(19) United States
(12) Patent Application Publication
(10) Pub. No.: US 2014/0000546 A1
(43) Pub. Date: Jan. 2, 2014

(54) System and Apparatus for Starting an Engine

(71) Applicant: Philip R. Hardy, Jacksonville, FL (US)

(72) Inventor: Philip R. Hardy, Jacksonville, FL (US)

(21) Appl. No.: 13/534,975

(22) Filed: Jun. 27, 2012

(51) Int. Cl. F02N 3/04; F02N 1/02

(52) U.S. Cl. 123/185.4; 74/6

(57) ABSTRACT

Disclosed is a system and apparatus for starting an engine. The apparatus includes a stand that can be erected in a folded configuration above the engine to be started. A lever arm is pivotally secured to the bottom portion of the stand. A cord extends from the engine, over the stand, and connects to the lever arm. A pulley may be used to route the cord over the stand. This allows the user to push down upon the lever arm to pull the cord and start the engine.

### TECHNICAL FIELD

This disclosure relates to a system for starting an engine. More specifically, the present disclosure relates to an apparatus for enabling an engine to be more easily started by a user.

### BACKGROUND OF THE INVENTION

Small internal combustion engines are in wide use throughout the world. These engines can be used to power such things as lawn mowers, leaf blowers, go-carts, outboard motors, and even lightweight aircraft. Unlike larger engines, which use an electric starter, small internal combustion engines are typically started via a recoil starting mechanism. Recoil starting mechanisms, also known as pull start mechanisms, include a rip cord and a handle. The cord is coiled around the end of a crank shaft. The cord must be rapidly pulled to turn the crank shaft and start the engine. If the cord is pulled with sufficient velocity, a fly wheel spins to start the engine. Once the engine is started, a coil spring inside an associated reel mechanism reverses direction and recoils the cord. Such recoil type starting mechanisms are used in a variety of different engines, such as two or four stroke engines.

One downside to recoil starting mechanisms is that a user must expend a great deal of energy in order to start the motor. The user must pull the cord with a sufficient amount of velocity to rotate the crank shaft and start the motor. If the cord is not pulled with enough force, the engine will not start. After a series of failed attempts, the engine can become flooded and unusable for a period of time. Failed attempts may also result in the cord becoming tangled about the crank shaft. Users can also become injured during repeated attempts at starting the motor. Many times these injuries take the form of a pulled shoulder muscle or, worse yet, a torn rotator cuff.

One way to avoid the problems associated with a recoil type starting mechanism is to employ an electric starter. Electric starting mechanisms are in common use in connection with larger engines, such as automobile engines. Electric starters, however, require the use of an electric battery. This, in turn, unduly increases the size, cost, and weight of the resulting engine. This may not be a realistic possibility for smaller engines. Thus, there exists a need in the art for a mechanism to more easily and effectively activate a recoil starting mechanism. There is likewise a need in the art to allow internal engines to be more easily and effectively started. The system and apparatus of the present disclosure is aimed at fulfilling these and other objectives.

### SUMMARY OF THE INVENTION

One of the advantages of the disclosed system is that it allows a user to easily and effectively activate a recoil starting mechanism and thereby start an associated internal combustion engine.

Another advantage of the disclosed system is that it gives a user a more effective lever arm as a means for pulling the rip cord associated with a starting mechanism.

A further advantage is that the disclosed system allows a user to start an internal combustion engine with his or her foot, thereby avoiding the use of the hands, arms, shoulder and back.

Another advantage is realized by providing a starting mechanism that can be folded into a flat configuration for storage and transport.

Various embodiments of the disclosed system may have none, some, or all of these advantages. Other technical advantages of the disclosed system will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a perspective view of the system of the present disclosure.

FIG. 2 is a perspective view of the system being employed by a user.

FIG. 3 is a perspective view of the system prior to being activated.

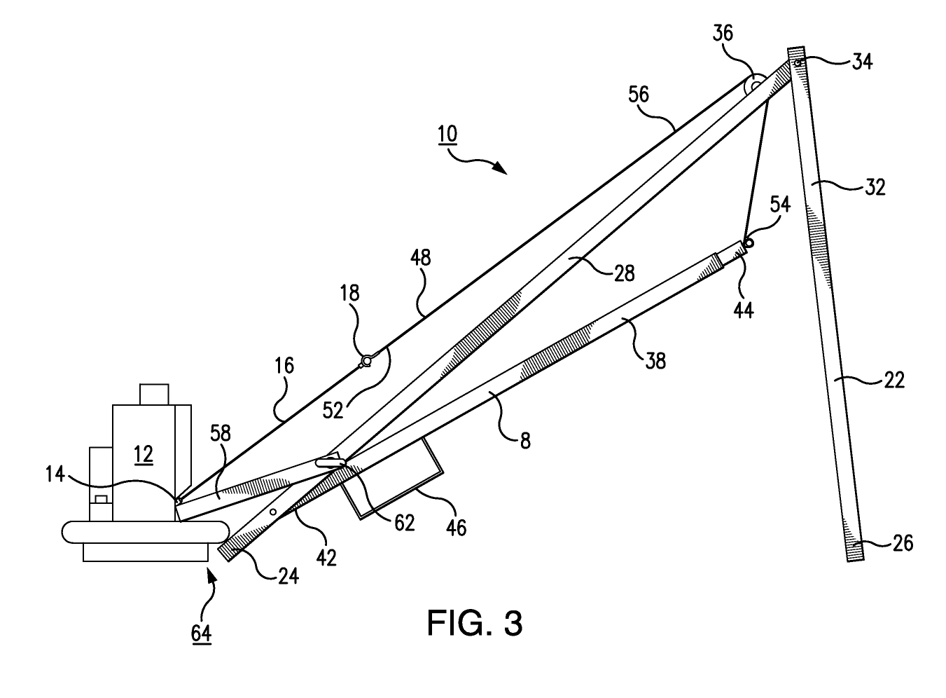

FIG. 4 is a perspective view of the system after being activated.

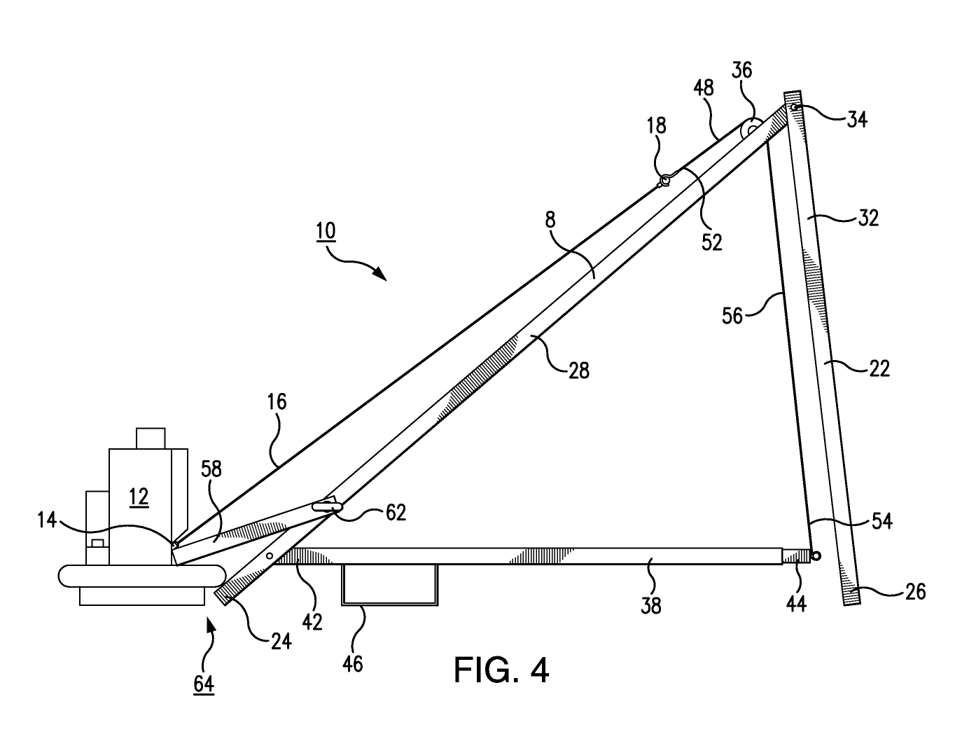

FIG. 5 is a bottom plan view of the system of the present disclosure.

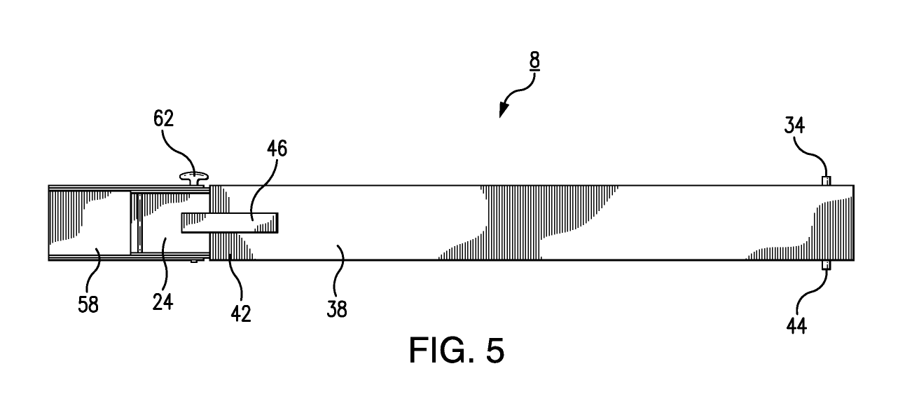

Parts List

| | |
|---|---|
| Apparatus 8 | Pulley 36 |
| System 10 | Lever Arm 38 |
| Engine 12 | Proximal End of Lever Arm 42 |
| Starting Mechanism 14 | Distal End of Lever Arm 44 |
| Rip Cord 16 | Footrest 46 |
| Handle 18 | Pulley Cord 48 |
| Stand 22 | First End of Pulley Cord 52 |
| Proximal End of Stand 24 | Second End of Pulley Cord 54 |
| Distal End of Stand 26 | Intermediate Extent of Pulley Cord 56 |
| First Leg 28 | Jaw 58 |
| Second Leg 32 | Wing Nut 62 |
| Pivot Point 34 | Clamp 64 |

### DETAILED DESCRIPTION OF THE DRAWINGS

The present disclosure relates to a system and apparatus for starting an engine. The apparatus includes a stand that can be erected in a folded configuration above the engine to be started. A lever arm is pivotally secured to the bottom portion of the stand. A cord extends from the engine, over the stand, and connects to the lever arm. A pulley may be used to route the cord over the stand. This allows the user to push down upon the lever arm to pull the cord and start the engine. The various details of the present invention, and the manner in which they interrelate, will be described in greater detail hereinafter.

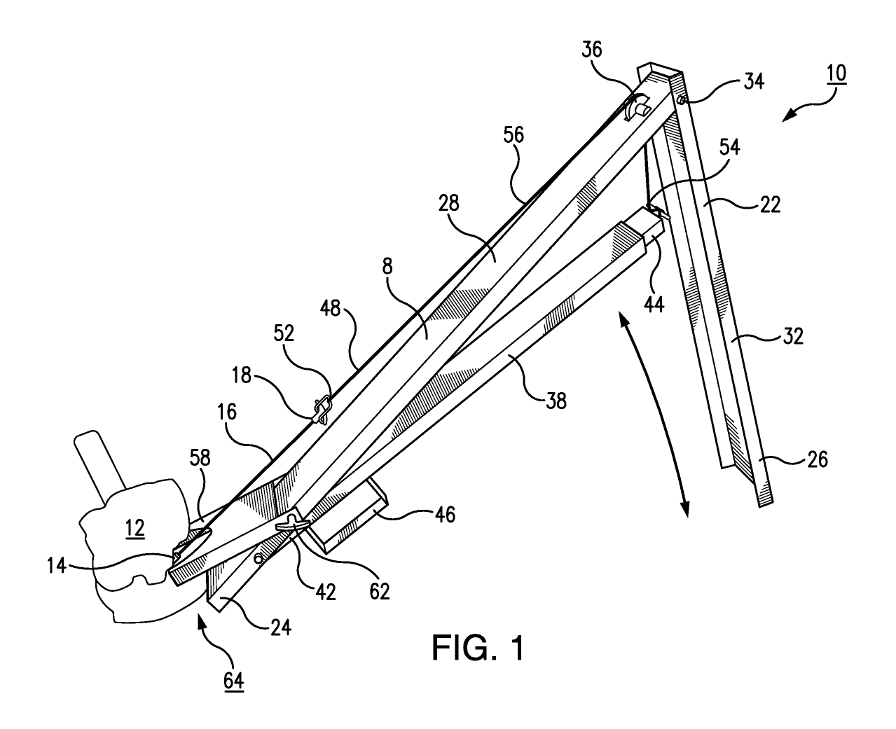

Turning now to FIG. 1, the apparatus 8 and associated system 10 of the present invention are disclosed. As explained in more detail hereinafter, apparatus 8 is utilized by a user to start an associated engine 12. System 10 encompasses both the apparatus 8 as well as the associated engine 12. Internal combustion engine 12 can be any of a wide variety of engines, including for example, small single or two stroke engines of the type commonly associated with lawn mowers, pressure washers, leaf blowers, go-carts, or outboard motors. Whatever type of engine 12 is utilized, it employs a starting mechanism in order to initially start the internal combustion engine. Starting mechanism 14 may be, for example, a recoil starting mechanism. Recoil starting mechanism are also called manual starters, pull starters, or zip starters. Starting mechanism 14 includes a rip cord 16 and a handle 18.

Apparatus 8 includes a stand 22. As depicted, stand 22 has a proximal end 24 that is adjacent the engine 12 to be started and a distal end 26 that is more remote from engine 12. In the depicted embodiment, stand 22 has an “A” shape and is defined by first and second legs (28 and 32). Legs 28 and 32 are pivotally interconnected to one another at a pivot point 34. Pivot 34 can comprise a link or bolt that is received within the ends of first and second legs (28 and 32) and that permits their relative rotation to one another. A pulley wheel 36 is secured via a rotatable connection to the first leg 28 at a location adjacent to pivot point 34.

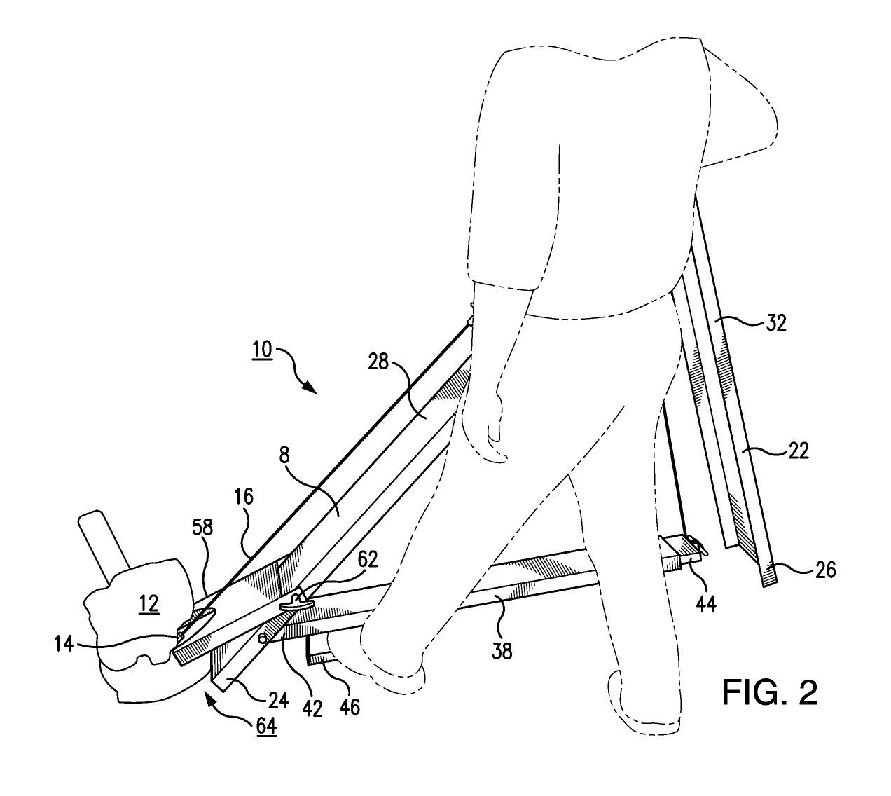

Apparatus 8 also includes a lever arm 38 that is interconnected to stand 22. Lever arm 38 includes a proximal end 42 adjacent stand 22 and a distal end 44 that is remote from stand 22. As illustrated in FIG. 1, proximal end 42 of lever arm 38 is pivotally connected to stand 22. As depicted in FIG. 2, proximal end 42 of arm 38 is pivotally interconnected to stand 22 at a location slightly above the proximal end 24 of stand 22. This allows arm 38 to be pivoted while the proximal end 42 of stand 22 is resting on the ground or upon the engine 12. The pivotal connection between stand 22 and arm 38 is accomplished, for example, by a pin or axle that is received within both arm 38 and stand 22. With further reference to FIG. 1, the footrest 46 of lever arm 38 is depicted. Footrest 46 extends from the bottom of lever arm 38 and is positioned at a location that is intermediate the proximate and distal ends (42 and 44) of lever arm 38. However, if preferred, footrest 46 can be positioned adjacent the distal end 44 of lever arm 38. Footrest 46 can be collapsible so that it sits flush against arm 38 for storage and transport.

The starting apparatus 8 includes a pulley cord 48. Pulley cord 48 is defined by first and second ends (52 and 54) and an intermediate extent 56. First end 52 of pulley cord 48 is removeably coupled to handle 18 of recoil starting mechanism 14. This can be accomplished in the most simple embodiment by forming a small loop at the second end 54 of pulley cord 48 and securing it about handle 18. The second end 54 of pulley cord 48 is secured to the distal end 44 of lever arm 38. Distal end 44 may include a cleat for the purpose of securing end 54. As depicted, pulley cord 48 is routed over pulley 36. Accordingly, when lever arm 38 is pushed downwardly, pulley cord 48 moves over pulley 36 to actuate rip cord 16 of internal combustion engine 12. Apparatus 10 also includes a jaw 58 that is pivotally secured to stand. As depicted in FIG. 2, jaw 58 is pivotally secured to a location slightly above proximal end 24 of stand 22. This can, again, be accomplished by an axle or linkage. Jaw 58 can be tightened by way of a wing nut 62. Jaw 58 and proximal end 24 of stand 22 together form a clamp 64 that is adapted to engage engine 12. In this regard the edge of jaw 58 can be curved or arcuate to accommodate the engine 12. Clamp 64 may be used, for example, when apparatus 8 is employed on a small appliance such as a leaf blower. Clamp 64 thereby prevents the small devices from being moved during the starting process. Alternatively, clamp 64 may need not be secured to the internal combustion engine if it is a larger device such as a lawnmower.

In operation, the user can secure clamp 64 to internal combustion engine 12. This may be done by adjusting the pivotal angle of jaw 58 with respect to stand. Once the appropriate angle is achieved, wing nut 62 can be used to tighten jaw 58. Thereafter, the user can insert his or her foot into footrest 46. The user then presses downwardly on footrest 46 to, in turn, push lever arm 38 downwardly. This has the effect of pulling pulley cord 48 and the attached rip cord 16.

Apparatus 8 essentially forms a type III lever. The user's foot is used to apply a downward force to lever arm 38. This force is used to increase the speed with which rip cord 16 is pulled. As a result, starting mechanism 14 can be more efficiently activated. Apparatus 8 has the benefit that the user's leg is used to supply the necessary starting force. The user, therefore, can avoid having to use his arms or shoulders to start the engine 12. This, in turn, lessens the possibility of injury, such as rotator cuff injuries. It also helps users avoid becoming fatigued via repeated attempts at activating starting mechanism 14.

When not in use, footrest 46 can be collapsed against lever arm 38. This is accomplished via hinged interconnections for all sides of the footrest 46. First and second legs (28 and 32) are also preferably channel shaped. Furthermore, arm 38 and first leg 28 preferably have widths that permits them to fit within the channel formed by second arm 32. This arrangement allows the entire apparatus 8 to be flattened for storage and transport.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system (10) for assisting a user in starting an internal combustion engine (12), the system (10) comprising:
an internal combustion engine (12) with a recoil starting mechanism (14), the recoil starting mechanism (14) including a rip cord (16) and a handle (18);
a stand (22) having proximal and distal ends (24 and 26), the stand (22) including first and second legs (28 and 32) that are pivotally interconnected at a pivot point (34), a pulley (36) secured via a rotatable connection to the first leg (28) adjacent the pivot point (34);
a lever arm (38) having proximal and distal ends (42 and 44), the proximal end (42) of the lever arm (38) being pivotally interconnected to the proximal end (24) of the stand (22), a footrest (46) secured to the lever arm (38) at a location intermediate the proximal and distal ends (42 and 44);
a pulley cord (48) having first and second ends (52 and 54) and an intermediate extent therebetween (56), the first end (52) of the pulley cord (48) being removably coupled to the handle (18) of the recoil starting mechanism (14), the second end (54) of the pulley cord (48) being secured to the distal end (44) of the lever arm (38), the intermediate extent (56) of the pulley cord (48) being routed over the pulley (36);
a jaw (58) pivotally secured to the stand (22) by way of a wing nut (62), the jaw (58) and the proximal end (24) of the stand (22) forming a clamp (64) that is adapted to engage the internal combustion engine (12);
whereby the user can secure the clamp (64) to the internal combustion engine (12) and position the distal end (26) of the stand (22) upon the ground, thereby elevating the pivot point (34) above the ground, the internal combustion engine (12) can thereafter be started by depressing the footrest (46) to pivot the lever arm (38), pull the rip cord (16), and activate the recoil starting mechanism (14).

2. An apparatus (8) for assisting a user in starting an engine (12), the engine (12) having a starting mechanism (14) and a rip cord (16), the apparatus (8) comprising:
a stand (22) having proximal and distal ends (24 and 26), the stand (22) including first and second legs (28 and 32) that are pivotally interconnected at a pivot point (34);
a lever arm (38) having proximal and distal ends (42 and 44), the proximal end (42) of the lever arm (38) being pivotally interconnected to the proximal end (24) of the stand (22);
a pulley cord (48) having first and second ends (52 and 54) and an intermediate extent therebetween (56), the first end (52) of the pulley cord (48) being removably coupled to the rip cord (16), the second end (54) of the pulley cord (48) being secured to the distal end (44) of the lever arm (38);
whereby the internal combustion engine (12) can be started by depressing the lever arm (38) to pull the rip cord (16), and activate the starting mechanism (14).

3. The apparatus as described in claim 2 wherein a jaw (58) is pivotally secured to the stand (22), the jaw (58) and the proximal end (24) of stand (22) forming a clamp (64) that is adapted to engage engine (12).

4. The apparatus as described in claim 2 wherein the second leg (32) includes an internal channel for receiving the lever arm (38) in a collapsed configuration.

5. The apparatus as described in claim 2 wherein the starting mechanism (14) is a recoil starting mechanism.

6. The apparatus as described in claim 2 wherein a footrest (46) is included on the bottom of the lever arm.

7. An apparatus (8) for pulling the rip cord (16) of an engine (12), the apparatus (8) comprising:
a stand (22) having proximal and distal ends (24 and 26), the stand (22) including first and second legs (28 and 32) that are pivotally interconnected at a pivot point (34), the first leg (28) formed from a channel having a first width, the second leg (32) being formed from a channel having a second width;
a lever arm (38) having proximal and distal ends (42 and 44), the proximal end (42) of the lever arm (38) being pivotally interconnected to the proximal end (24) of the stand (22), the lever arm (38) having a third width;
a pulley cord (48) having first and second ends (52 and 54) and an intermediate extent therebetween (56), the first end (52) of the pulley cord (48) being connected to the rip cord (16), the second end (54) of the pulley cord (48) being secured to the distal end (44) of the lever arm (38);
the second width being greater than the first and third widths to thereby permit the first leg (28) and the lever arm (38) to fit within the second leg (32) for storage and transport.

8. The apparatus as described in claim 7 wherein a footrest is positioned at a point along the length of the lever arm (38), the footrest (46) having a collapsed configuration wherein it lies relatively flat upon a face of lever arm (38), and the footrest (46) having an erect orientation wherein it is spaced from the face of lever arm (38).
